(19) United States
(12) Patent Application Publication
(10) Pub. No.: US 2009/0084565 A1
(43) Pub. Date: Apr. 2, 2009

(54) Welded hand rank/fork tool with welded tine and method

(76) Inventor: Peter W. Lesche, Millville, NJ (US)

Correspondence Address: Hollstein Keating Cattell Johnson & Goldstein PC;Willow Ridge Excutive Office Park, 750 Route 73 South, Suite 301, Marlton, NJ, 08053, US

(21) Appl. No.: 12/072,525

(22) Filed: Feb. 27, 2008

Related U.S. Application Data
(60) Provisional application No. 60/997,287, filed on Oct. 2, 2007.

(51) Int. Cl. A01B 1/14

(52) U.S. Cl. 172/378; 228/185

(57) ABSTRACT

A smoothing/sifting rake, fork, pitchfork, or similar forked hand tool or attachment or tool head for mechanized machinery has specially welded tines. The tines each have a lower section located on the backbone of the tool head and a working section extending outwardly from the backbone. Each tine also has two longitudinally extending lateral surfaces and a transversely extending back edge surface therebetween. In one embodiment, welds extend the full longitudinal length of one of the lateral surfaces, the full transverse length of the back edge surface, but only partially along the longitudinal length of the second lateral surface. For heavy duty applications, welds are not applied to the back edge surface. The tool and machinery attachments with tines welded in this manner, in accordance with the unique method of welding, provides for increased strength of the tine to backbone juncture, thereby eliminating total separation of the tine from the backbone and preventing premature fracture of the tine along the leading edge of the backbone. The tines have elongated fracture lines and the resulting tool or attachment is much stronger and far less prone to breakage.

This application claims the benefit of provisional application Ser. No. 60/997287, filed on Oct. 2, 2007.

### BACKGROUND OF THE INVENTION

The invention relates to the field of rakes, pitchforks, and similar forked hand tools, as well as attachments for mechanized machinery used for ground sifting, bucket digging, cultivating, and dethatching. All such tools and machinery are used in the handling of loose or compacted materials, especially in the performance of heavy work done by gardeners, landscapers, nurserymen, hardscapers, contractors, road builders, farmers and like workers. The tines on the types of tools and mechanized machinery attachments to which the invention relates are attached at one end to the backbones of these tools and machinery and are free at their other ends. It has been found that under hard usage, the tines of these type tools and machinery attachments, welded to the backbones using known welding methods, or if they are improperly welded, will either totally separate from the backbone or fracture/break off, leaving a stub still attached to the backbone. An annealing process occurs when attempts are made to reweld the damaged tine to the backbone. This results in further weakening of the backbone and the surrounding tines. Attempts at reheat treating the effected areas or the entire tool have proven to be cost prohibitive and fruitless in strengthening the tine to backbone connection.

### SUMMARY OF THE INVENTION

It is an object of the present invention to overcome the disadvantages and limitations of prior welded forked tools.

It is an object of the present invention to provide a welded forked tool constructed with tines which are welded to the tool backbone so as to prevent and virtually eliminate tine breakage from the tool.

It is another object of the present invention to provide a welded forked tool constructed with tines which are more durable than those tines on existing tools.

It is a further object of the present invention to provide a welded forked tool which will retain all its welded tines for the full life of the tool.

It is still another object of the present invention to provide a welded forked tool constructed with tines which eliminates the continual frustration and costs associated with replacement of inferior tools.

It is another object of the present invention to provide a method of welding tines of forked tools to the backbone of the tools so as to prevent and virtually eliminate tine breakage from the tools.

It is a further object of the present invention to provide a method of welding tines of forked tools to the backbone of the tools so as to ensure that a forked tool will retain all its tines for the full life of the tool.

It is still another object of the present invention to provide a method of welding tines of forked tools to the backbone of the tools so as to eliminate the continual frustration and costs associated with replacement of inferior tools.

These and other objectives are accomplished by the present invention, a smoothing/sifting rake, fork, pitchfork, or similar forked hand tool or attachment or tool head for mechanized machinery with specially welded tines. The tines each have a lower section located on the backbone member of the tool head and a working section extending outwardly from the backbone. Each tine also has two longitudinally extending lateral surfaces and a transversely extending back edge surface therebetween. In one embodiment, welds extend the full longitudinal length of one of the lateral surfaces, the full transverse length of the back edge surface, but only partially along the longitudinal length of the second lateral surface. For heavy duty applications, welds are not applied to the back edge surface. The tool and machinery attachments with tines welded in this manner, in accordance with the unique method of welding, provides for increased strength of the tine to backbone juncture, thereby eliminating total separation of the tine from the backbone and preventing premature fracture of the tine along the leading edge of the backbone. The tines have elongated fracture lines and the resulting tool or attachment is much stronger and far less prone to breakage.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric view of an exemplar tined tool, welded in accordance with the present invention.

FIG. 2 is a top view showing a prior tine weld configuration.

FIG. 3 is a top view showing an alternate prior tine weld configuration.

FIG. 4 is a top view of tines welded in accordance with the present invention.

FIG. 5 is a top view of the tines welded for heavy duty application, in accordance with the present invention.

FIG. 6 is an isometric view of tines welded for heavy duty application in accordance with the present invention.

### DETAILED DESCRIPTION OF THE INVENTION

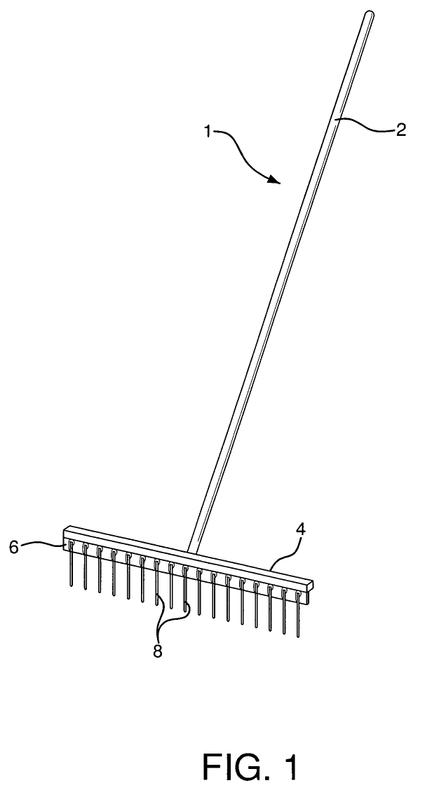

Rake 1, in FIG. 1, shows an exemplar tined tool employing the tine welding technique of the present invention. Rake 1 has handle 2 secured to tool head 4 comprising backbone member 6 with tines 8 welded thereto. Backbone member 6 can be separately attached by bolts or equivalent fastening means, or it can be integral to the handle.

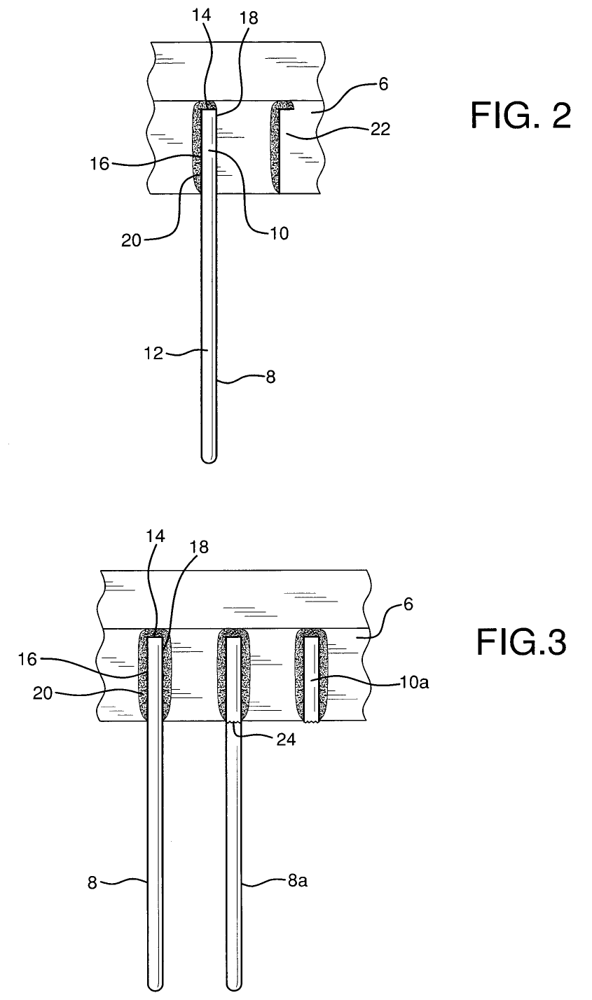

FIGS. 2 and 3 show current tine to backbone welding techniques. Tine 8 in these FIGs., and in all the FIGs. discussed herein, comprises a main body with lower section 10 welded to backbone member 6 and working section 12, outwardly extending from the backbone member. Lower section 10 has back edge surface 14, with a relatively short transverse length, and first and second lateral surfaces 16 and 18, each with longitudinally extending lengths forming part of the overall longitudinal length of each tine 8.

With specific reference to FIG. 2, weld material 20 is laid on backbone member 6, along the full longitudinal length of one lateral surface 16 and along back edge surface 14 of tine 8. In this common welding configuration, tine 8 likely will be caused to simply break off backbone member 6 (at 22) in its entirety, when tool 1 is put to heavy usage or when the tine itself strikes a hard object such as a rock.

With specific reference to FIG. 3, weld material 20 is laid on backbone member 6, along back edge surface 14 and the full longitudinal lengths of both lateral surfaces 16 and 18 of tine 8. This creates a short fracture line 24 and upon heavy usage of tool 1, this commonly used welding configuration will cause tine 8a to break off at fracture line 24, leaving only lower section 10a of the tine remaining on backbone member 6. Fracture line 24, being short, results in the tine having a greater tendency to break at the fracture line.

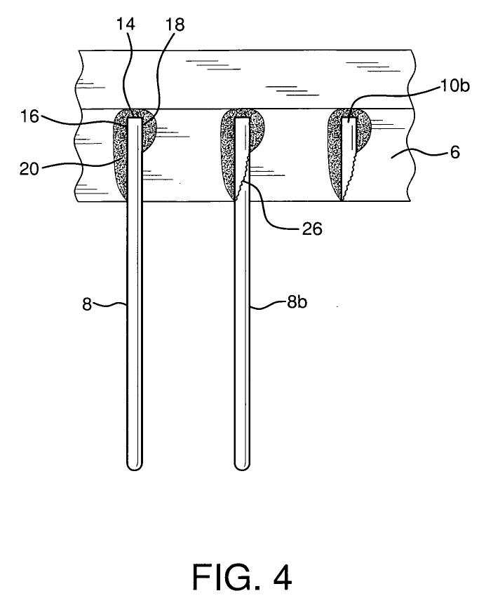

The welding configuration of the present increases to the length of the fracture lines of tines and thus greatly increases the strength of the tines. FIG. 4 shows tine 8 welded in accordance with the invention. Weld material 20 is laid on backbone member 6 along the full longitudinal length of one lateral surface 16, along the transverse length of back edge surface 14, and only partially along the longitudinal length of lateral surface 18. It has been found that weld material 20 can be laid halfway or slightly less than halfway along the longitudinal length of lateral surface 18, for optimizing the welded tine to backbone connection and thus increasing the length of the tine's fracture line. As seen in FIG. 4, it would be more difficult for tine 8b to fail, since it has an elongated fracture line 26. If tine 8 was to fail, it would do so along this substantially elongated fracture line 26, leaving less of lower section 10b attached to backbone member 6.

Thus the weld configuration of the invention prevents tines from breaking away from the backbone member, as compared to tines which are only welded on one side completely or where wells are located completely and equally around the tines. The invention extends or elongates the stress or fracture line across the tines, extending from the end of the front edge weld across the tine to the opposite side, terminating at the edge of the opposite weld, in a diagonal line, as at 26, instead of straight across, as at 24. This greatly increases the strength of the tine, resulting in a tine that is far stronger and secure in its attachment.

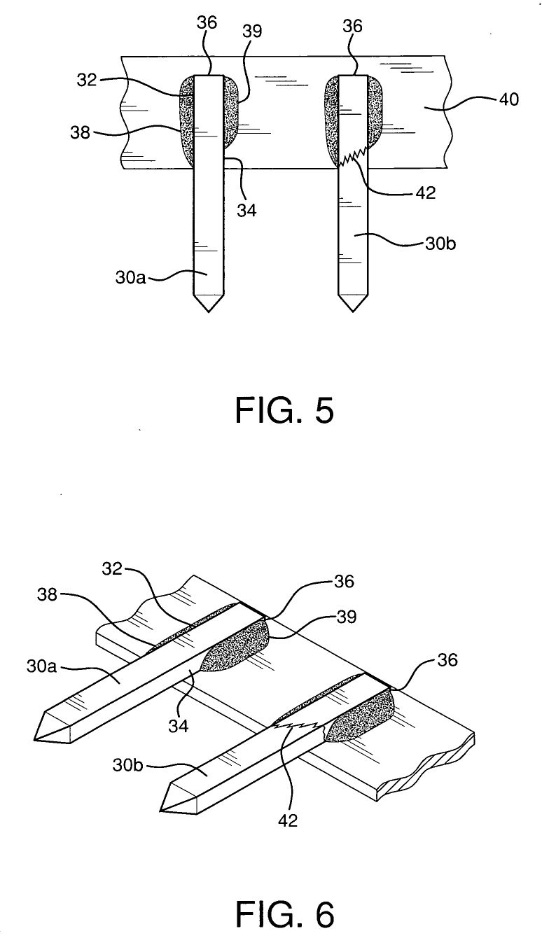

FIGS. 5 and 6 show the tine to backbone configuration employed for heavy duty application, such as would be employed on attachments or tool heads of mechanized machinery used for ground sifting, digging, and cultivating. Larger, more substantive tines 30a and 30b are welded onto supporting backbone member 40 of an attachment or tool head. In this embodiment, weld 38 is laid along the full longitudinal length of one lateral surface 32 and weld 39 is laid partially along the second lateral surface 34. Given the size of the tines and the much greater weld to backbone surface area, no weld is necessary along back edge surface 36. Using this weld configuration, tines 30a and 30b, once again, will be far less prone to fail, as a result of substantially elongated fracture line 42.

The tines of the present invention can also be welded by a robot employing skip welding all around the head, to minimize warpage and alloy burnout.

It is contemplated that not each tine need be fully welded down the same side. The completely welded side can be on alternating tines or randomly located on the tines.

After all tines are welded into place, it is contemplated that the completed assembly will be heat treated to provide maximum strength and durability. The heat treatment clamps the hot assembly securely, thus eliminating the warpage associated with tine welding and furnace heating.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A hand tool comprising:
a handle;
a tool head connected to the handle;
a plurality of tine members, each tine member having a lower section attached to the tool head and a working section extending outwardly from the tool head, the lower section of each tine member comprising first and second lateral surfaces with longitudinal lengths and a back edge surface with a transverse length extending between the lateral surfaces, all the surfaces being in direct contact with the tool head; and
means to permanently secure the tines to the tool head, said means comprising welds located between the lateral surfaces and the tool head and between the back edge surface and the tool head, the welds extending the full longitudinal length of the first lateral surface, the full transverse length of the back edge surface, and only partially along the longitudinal length of the second lateral surface, whereby the means to permanently secure the tines to the tool head establishes an elongated fracture line across each tine.

2. The hand tool as in claim 1 wherein the welds extend halfway along the longitudinal length of the second lateral surface.

3. The hand tool as in claim 1 wherein the welds extend less than halfway along the longitudinal length of the second lateral surface.

4. A tool head comprising:
a supporting backbone member;
a plurality of tine members, each tine member having a lower section attached to the backbone member and a working section extending outwardly from the backbone member, the lower section of each tine member comprising first and second lateral surfaces with longitudinal lengths and a back edge surface with a transverse length extending between the lateral surfaces, all the surfaces being in direct contact with the backbone member; and
means to permanently secure the tines to the backbone member, said means comprising welds located between the lateral surfaces and the backbone member, the welds extending the full longitudinal length of the first lateral surface and partially along the longitudinal length of the second lateral surface, whereby the means to permanently secure the tines to the backbone member establishes an elongated fracture line across each tine.

5. The tool head as in claim 4 wherein the welds extend halfway along the longitudinal length of the second lateral surface.

6. The tool head as in claim 4 wherein the welds extend less than halfway along the longitudinal length of the second lateral surface.

7. The tool head as in claim 4 wherein the welds are located between the back edge surface and the backbone member, the weld extending the full transverse length of the back edge surface.

8. The method of permanently securing tine members to a hand tool, the method comprising the steps of:
providing a tool head member;
providing a plurality of tine members, each tine member having a lower section and a working section, the lower section of each tine member comprising first and second lateral surfaces with longitudinal lengths and a back edge surface with a transverse length extending between the lateral surfaces;
positioning each tine member on the tool head such that the lower section of each tine member is located on the tool head with its back edge surface and lateral surfaces in direct contact with the tool head and such that the working section of each tine member extends outwardly from the tool head;
applying a weld along the full longitudinal length of the first lateral surface of each tine member where said lateral surfaces are in direct contact with the tool head;
applying a weld along the full transverse length of the back edge surface of each tine where said back edge surfaces are in direct contact with the tool head;
applying a weld along only the partial longitudinal length of the second lateral surface of each tine member where said lateral surfaces are in direct contact with the tool head; and
establishing an elongated fracture line along each of the tine members.

9. The method as in claim 4 comprising the additional step of applying a weld halfway along the longitudinal length of the second lateral surface.

10. The method as in claim 4 comprising the additional step of applying a weld less than halfway along the longitudinal length of the second lateral surface.

11. The method of permanently securing tine members to a backbone member, the method comprising the steps of:
providing a backbone member;
providing a plurality of tine members, each tine member having a lower section and a working section, the lower section of each tine member comprising first and second lateral surfaces with longitudinal lengths and a back edge surface with a transverse length extending between the lateral surfaces;
positioning each tine member on the backbone member such that the lower section of each tine member is located on the backbone member with its back edge surface and lateral surfaces in direct contact with the backbone member and such that the working section of each tine member extends outwardly from the backbone member;
applying a weld along the full longitudinal length of the first lateral surface of each tine member where said lateral surfaces are in direct contact with the backbone member;
applying a weld along only the partial longitudinal length of the second lateral surface of each tine member where said lateral surfaces are in direct contact with the backbone member; and
establishing an elongated fracture line along each of the tine members.

12. The method as in claim 11 comprising the additional step of applying a weld halfway along the longitudinal length of the second lateral surface.

13. The method as in claim 11 comprising the additional step of applying a weld less than halfway along the longitudinal length of the second lateral surface.

14. The method as in claim 11 comprising the additional step of applying a weld along the full transverse length of the back edge surface of each tine where said back edge surfaces are in direct contact with the backbone member.
